(19) United States
(12) Patent Application Publication
(10) Pub. No.: US 2020/0147942 A1
(43) Pub. Date: May 14, 2020

(54) Packaging Laminate and Method for Forming a Packaging Having a Functional Element

(71) Applicant: SIG Technology AG, Neuhausen am Rheinfall (CH)

(72) Inventors: Steffen Reisert, Aachen (DE); Lars Malindretos, Krefeld (DE)

(21) Appl. No.: 16/631,052

(22) PCT Filed: Jul. 10, 2018
(86) PCT No.: PCT/EP2018/068605

§ 371 Date: Jan. 14, 2020

(30) Foreign Application Priority Data
Jul. 18, 2017 (DE) 10 2017 116 170.8

(51) Int. Cl. B32B 27/08; B32B 15/085; B32B 15/12; B32B 15/20; B32B 27/10; B32B 27/30; B32B 27/32; B32B 27/34; B32B 3/30; B32B 37/20; B32B 7/12; H01Q 1/22; G06K 19/077

(52) U.S. Cl. CPC B32B 27/08; B32B 2307/7244; B32B 15/12; B32B 15/20; B32B 27/10; B32B 27/304; B32B 27/306; B32B 27/32; B32B 27/34; B32B 3/30; B32B 37/203; B32B 7/12; H01Q 1/2225; G06K 19/07779; B32B 2307/20; B32B 15/085

(57) ABSTRACT

Described and represented is a packaging laminate for forming a packaging for flowable products, comprising a structuring carrier layer made of a fibrous material, and outer cover layers made of plastic. In order to be able to provide the user with individual information relating to the packaging and/or the packaged product in a simpler, more accurate and/or more cost-effective manner, at least one functional element, designed as a chip unit, antenna unit, sensor unit and/or transponder unit, is provided between the carrier layer and a cover layer and/or at least partially in the carrier layer and/or at least partially in a cover layer, preferably at regular intervals.

The invention relates to a packaging laminate for forming a packaging for flowable products, comprising a structuring carrier layer made of a fibrous material, and outer cover layers made of plastic. The invention also relates to a method for producing a packaging laminate for forming a packaging for flowable products.

Packaging in the context of the present invention is intended to mean what are known as composite packagings, but which are referred to for simplicity as packaging. The fact that the packaging of the invention relates to composite packagings is indicated simply by the use of a packaging laminate for forming the packaging comprising various material layers. Hence the packaging laminate is a composite material for creating a composite packaging.

Composite packagings are essentially formed of packaging materials bonded together that form a flat, layered structure or what is known as the packaging laminate. Cardboard composite packaging has a cardboard layer, which provides the packaging with its basic stability and basic structure. The cardboard layer thus forms the structuring carrier layer, which consequently at least substantially also determines the flexural rigidity of the packaging laminate, but in particular largely provides this. Put another way, the packaging laminate and the packaging produced therefrom retains or retain its or their form due to the structuring carrier layer.

The carrier layer also supports directly or indirectly cover layers made of plastic arranged either side of the carrier layers. The carrier layers form the outer ending of the laminate or the packaging produced therefrom, while printing on the cover layers is still possible. Here the printing as such is not considered to be a separate layer of the packaging laminate but part of the cover layer, even though the printing and the cover layer usually consist of different materials. However, the printing is usually much thinner than the cover layer as such. The cover layers serve, by way of example, as liquid barriers. Thus, by way of example, the ingress of flowable products into the packaging laminate, in particular the cardboard layer, or even the leaking of flowable products can be avoided as can the ingress of moisture from outside. Thermoplastics, through the formation of firmly bonded weld seams, can also be sealed, thereby forming a pack and closing the packaging. Consequently, the cover layers are currently formed mainly from a polyolefin, in particular polyethylene.

The packaging laminate can have further layers and packaging materials. Thus, by way of example, an aluminium layer provides a barrier effect against gases and light. To be able to fold, i.e. mechanically fold, the flat packaging laminate, creases are often made in the packaging laminate, which predefine the subsequent fold lines. The folds form the packaging edges on the packaging and/or allow the shaping of the packaging base and or packaging top. Packaging laminates are also usually printed with a decoration.

Packaging laminates are usually produced as continuous webs which are wound onto a roll as rolled goods. The individual layers of the packaging material, in particular the carrier layer, are unrolled from a roll and laminar bonded with other layers, which are similarly unrolled from a roll or extruded in line with the packaging laminate production and then bonded with the material web. However, layers can also be rolled on or the material web drawn through a material bath in order to form a further material layer. The latter may in particular be considered for the application of bonding agents or adhesives for bonding adjacent material webs. However, for suitable material pairings, the material layers can be bonded directly to one another.

Hence, the packaging laminate can be prepared as a web material or continuous material, in particular as a rolled good, from which, without initially generating a blank, a pack can be directly formed. Here, the rolled good is initially bent, and sealed along its longitudinal edges to form a tube, and in the longitudinal direction sealed so that it is fluid tight. Then fluid-tight transversal seams at regular intervals provide a seal. The product can then respectively be filled into the upwardly open tube pockets, before the tube pockets are sealed by the respective next transversal seam to form packagings.

Alternatively, prior to the forming of the pack the packaging laminate can be cut in the longitudinal and/or transversal direction, thereby generating what are known as blanks.

These can be further processed into so-called packaging shell preforms in the form of packaging shells or packaging sleeves. To this end the longitudinal edges are lapped and sealed together forming a longitudinal weld seam. In this way, as required, tubular packaging sleeves are formed, which are folded flat and stacked for further processing at another location, in particular in a filling machine. In the filling machines, a formed and filled packaging can then be produced from the packaging sleeves.

The packaging is typically filled with products in the form of foodstuffs, in particular drinks, wherein as products it is mainly flowable products that are considered. Here, in particular, the filling of the packaging bodies with foodstuffs takes place in a sterile or aseptic environment of a filling machine, since after filling the packaging the foodstuff must have a long shelf life. To this end the filling machines, by way of example, have sterilisation spaces or aseptic chambers, in which the packaging bodies can be sterilised and then filled under the most sterile possible conditions and then sealed. After filling of the packaging bodies these are typically sealed in the filling machine. When such packaging materials are used, the packaging body is closed off by sealing the open end.

Flat-folded packaging sleeves are passed as a stack to a magazine of the filling machine and unfolded one after the other. The unfolding takes place along pre-folded fold lines, at which the packaging laminate can be slightly kinked or folded. The correspondingly folded packaging sleeve is then pulled onto a mandrel of what is known as a mandrel wheel. Here, the packaging sleeve initially protrudes outwardly beyond the mandrel, so that the protruding part of the packaging sleeve can be folded against the front of the mandrel and pressed and sealed, and thus closed off, there. The closed off end of the packaging sleeve can subsequently form the base or the top of the packaging.

The packaging bodies thereby created with one side open are channelled into a sterilisation zone of the filling machine, where they are transported at a defined speed and at a defined distance from one another through the sterilisation zone of the filling machine. In the sterilisation zone, the packaging bodies are preheated with hot sterile air and then sterilised, typically with hydrogen peroxide, and dried with sterile air. The sterile packaging bodies are transferred to the filling and sealing zone where they are filled. Then the opening of the filled packaging bodies is closed off, before the closed off packaging is transported via the transport device out of the filling and sealing zone and then removed from the corresponding cells of the transport device.

In some filling machines, the packaging bodies are transported by a transport device, for instance a cell chain, in a straight line through the filling machine. Such filling machines are also called inline machine. In other filling machines, the so called rotary machines, the packaging bodies undergo a more or less curved movement, that can comprise one or more circular arc sections.

The product to be accommodated in the packaging is preferably a foodstuff, in particular a drink, and can if necessary comprise chunky parts. Basically, the products are pourable or free-flowing in particular flowable. Particularly preferred is corresponding packaging for accommodating a foodstuff comprising at least one liquid component.

Increasingly extensive requirements are being placed on the packaging. A modern trend is obtaining additional information about the packaging or the packed product that is not printed on the packaging or that it is not practicable to print on the packaging. This information can be packaging-specific or tailored to the packaging. Thus, if necessary, the end customer can, by way of example, obtain from each packaging when precisely the packaging was filled, with what product or what product batch the packaging was filled, at what location the packaging was filled, to which batch the packaging belongs, on which filling machine the packaging was filled, and so on. For all these purposes it is necessary to be able easily write various items of information to the packages to, which at the time of production of the packaging laminate were not yet actually known, but which could only be indicated shortly before, at the time of and/or after filling. To this end, it has already been proposed to stick RFID transponders to packaging. Here the term RFID stands for Radio-Frequency Identification or the identification by using electromagnetic waves. RFID transponders allow information to be stored on the transponder and for this information to be read out again without own energy of the transponder.

It is also desirable to obtain information on the current status of the filled product, for instance on whether the product meets the minimum requirements and/or is still suitable for consumption. The shelf life of products, such as for example foodstuffs, is highly dependent upon the handling of the packaging, in particular the cooling of the packaging after filling. The known use-by date only indicates a minimum shelf life that can be achieved with the envisaged cooling. Whether the product at this point in time, or even long afterwards, is actually usable or consumable without problems, can usually not be read off from the outside of the packaging.

To gain more transparency here, sensors are known which capture the cooling chain or cooling during the handling of the packaging and signal certain deviations, which may suggest problems with the usability of the products. These sensors can be mounted on outer packaging, in order to monitor entire batches of packaging or glued to individual packagings. However, the sensors are able to provide only vague information and the sensors themselves are very costly.

Therefore, the object of the present invention is to develop and improve the packaging laminate and the method for producing a packaging laminate of the respective type mentioned above and previously described in more detail in order to provide the user with individual information relating to the packaging and/or the packaged product in a simpler, more accurate and/or more cost-effective manner.

This object is achieved by a packaging laminate according to the preamble of claim 1 in that at least one functional element, designed as a chip unit, antenna unit, sensor unit and/or transponder unit, is provided between the carrier layer and a cover layer and/or at least partially in the carrier layer and/or at least partially in a cover layer, preferably at regular intervals. The functional element can be an electrical, electronic, electrochemical and/or chemical functional element and/or contain electrical, electronic, electrochemical and/or chemical components. In particular a sensor can have an electronic, electrochemical or chemical design or comprise electronic, electrochemical or chemical components. A chip unit can in particular contain electronic components. An antenna unit can in particular contain electrical components.

Said object is further achieved according to claim 12 by a method for producing a packaging laminate for forming a packaging for flowable products
in which a structuring carrier layer made of a fibrous material is bonded with outer cover layers made of plastic, in particular laminated, and
in which at least one functional element, designed as a chip unit, antenna unit, sensor unit and/or transponder unit, is provided between the carrier layer and the cover layer and/or at least partially in the carrier layer and/or at least partially in a cover layer, preferably at regular intervals.

Hence, according to the invention, it has been identified that to provide the desired information for the user at least one functional element can be integrated into the packaging laminate, between the carrier layer and a cover layer and/or at least partially in the carrier layer or cover layer. This simplifies the production of the packaging laminate and the application of the electrical functional part. Here, the structuring and relatively stiff carrier layer can be used. Thus, the carrier layer forms a suitable substrate for applying and accommodating the at least one functional element. Alternatively, or additionally, the carrier layer has a protective function for the functional element, so that this can be durably accommodated in the packaging laminate without being damaged. Thus, by way of example, following production the packaging laminate can be rolled up to a roll in order to then be taken to another location. The carrier layer protects the at least one functional element from damage, in particular from kinking or excessive bending. But the functional element can also be protected by the carrier layer during formation of the packaging and in the packaging itself. The flexural rigidity of the carrier layer can similarly be used during incorporation of the functional element at least partially in the carrier layer. In addition, a low layer thickness of the packaging laminate can be maintained without having to accommodate the functional unit at least partially in the carrier layer. Furthermore, if necessary contact between the functional element and the outer side of the packaging laminate or the inner side of the subsequent packaging can be provided.

The above applies in particular if the functional element is provided on the side of the carrier layer associated with the inner side of the packaging. Similar protection of the functional element is achieved if the functional element is accommodated at least partially in the carrier layer. Here also, the carrier layer protects the functional element and since the functional element is not arranged completely outside of the carrier layer, during further handling of the packaging laminate or the packaging formed from it, damage to the functional element, in particular from the shearing forces acting on the packaging laminate can be avoided.

In particular in the particularly preferred case where the packaging laminate is produced as a strip material or continuous material, from which a whole range of packaging can then be produced, it is expedient that the at least one functional element is provided repeatedly and with intermediate spacing along the strip material. It is quite particularly preferred here if the functional elements are provided uniformly at regular intervals along the strip material. This simplifies the formation of a whole series of identical packaging from the packaging laminate in the form of strip material. Here, the functional elements are more preferably spaced apart in the longitudinal direction, in order to allow the strip material to be expediently further processed in the longitudinal direction for formation of the packaging. However, functional elements can also be provided spaced apart in the transverse direction, in particular at regular intervals. This is especially the case if the packaging laminate is separated in the longitudinal direction in order to form packaging from the respective individual sections of strip thereby obtained.

In the following, for the sake of simplicity and to avoid unnecessary repetition, the packaging laminate and the method of its production will be described together without making a detailed distinction between the packaging laminate and the method. However, given the context it is clear to the person skilled in the art which specific feature is particularly preferred for the packaging laminate and the method respectively.

In a first particularly preferred configuration of the packaging laminate the chip unit has at least one microchip and connections for connecting the chip unit to an antenna unit. Here, the microchip comprises an integrated circuit which can preferably comprise at least one storage unit for storing information and a readout logic for reading out the stored information. If necessary, the chip unit can further comprise a carrier element for accommodating the microchip. The storage unit can constitute a volatile or a non-volatile memory. By way of example, data can be stored during production of the packaging laminate. By way of example, unique IDs or production data can be stored. Alternatively, or additionally, data can be stored at the filling machine and/or various points in the value-added chain. For instance, the data may relate to the filling machine and/or the product.

Alternatively, or additionally, the antenna unit can comprise at least one conductor path, preferably in the form of a conductor spiral or conductor coil, and/or connections for connecting the antenna unit to a chip unit. Here the antenna unit allows the reading out of the stored information of the chip unit. Radio antennas are preferably intended here, such as those typically used in RFID (Radio Frequency Identification) transponders or NFC (Near Field Communication) tags. Elements that can be read out by inductive coupling can in particular be considered here for the antenna unit. Furthermore, it can be expedient if the antenna unit comprises a carrier element for accommodating the conductor path. The antenna unit and the chip unit can also be arranged on a common carrier element.

Irrespective of this, the sensor unit can comprise at least one measuring sensor and/or measuring transducer that can be influenced by a measured variable. Here, the measuring sensor and/or measuring transducer can be arranged directly at least in part on the outer side of the cover layer, the subsequent inner side of the packaging, or penetrate the cover layer in the direction of the product. This serves for the direct capture of the at least one property of the filled product. However, the measuring sensor and/or measuring transducer can also be provided at least in part within the cover layer and in particular between the cover layer and the carrier layer. Thus, the measuring sensor and/or measuring transducer is/are better protected from external influences but can nevertheless be used to capture at least one property of the product. The measuring sensor and/or measuring transducer essentially capture certain physical, chemical and/or material properties of the near surroundings in a qualitative or quantitative manner, wherein this capture alters the properties of the sensors such that these can be read out or corresponding information passed on.

The measuring sensors can be active and generate an electrical signal as a result of the measurement. However, preference is for multiple passive measuring sensors, which must be powered in order to read out the measurement results. Sensor units considered are, by way of example, those for capturing the temperature, the pH value or the electrical conductance of a substance, the concentration of a substance, or similar. The substance can provide indicators as to the changes in quality over time of the product and by way of example may be a metabolite, trace element or vitamin. The capture of the corresponding measured value can take place directly or indirectly. Furthermore, an absolute capture of the measured value is unnecessary. Relative measured value capture can be sufficient. By way of example, following filling of the product in the packaging to begin with an initial value can be captured and stored. Subsequently, a further measured value can then be captured and compared with the stored initial value. The quality of the filled product can then be ascertained from the relative change. If necessary, a check is made on whether the change in the measured value has exceeded a specified limiting value and only this information is provided for reading out. The methods described allow a more cost-effective measurement sensor to be used for the sensor unit.

Irrespective of this, capture of the measured value may be desirable without direct contact with the filled product in order not to impair the product and to protect the sensor unit from external influences. Thus, by way of example, the temperature of the inner cover layer, the pH value of the inner cover layer, the presence of a substance in the inner cover layer or the concentration of a substance in the inner cover layer can be measured in order to obtain a reliable statement on the filled product. In this connection, it is appropriate if the substance to be measured can diffuse from the product into the inner cover layer.

Sensor units which work with a potentiometric measuring method require a reference electrode in order to provide a constant potential, from which the electrode potential of the measurement electrode can be measured. The most common form of reference electrode is a silver-silver chloride (Ag/AgCl) electrode. The smaller the reference electrodes, the more unstable they are. Depending on the material pairing, in particular together with chlorides, contact with foodstuffs is also undesirable. It is therefore preferred to use pseudo-reference electrodes, for instance in the form of simple metal wires or metal surfaces, on which a constant but unknown potential is set in an electrolyte solution.

The measuring principle of redox cycling manages without reference electrodes. Here, through reciprocal application of a potential on two electrodes in the analyte solution, by way of example the product to be analysed, in particular foodstuffs or a component or a parameter of the foodstuff to be analysed, a measurable current is generated which, dependent upon the analyte concentration, results from redox reactions of the analyte at the electrodes. In a particularly simple embodiment, a corresponding sensor consists of precisely two electrodes. However, multiple electrode arrangements, with the inclusion also of a reference electrode, are also conceivable. Here, the electrodes can be constructed as simple metal wires or fully or partially structured, flatly applied electrode structures. Here, in particular through the use of functional inks in combination with various printing methods, cost-effective sensor structures can be created on film substrates, in particular the cover layer.

In the case of a measurement sensor that is a temperature probe, active temperature probes, which due to the measurement principle generate a signal and therefore do not require auxiliary power for signal readout, and passive temperature probes, such as for instance resistance thermometers, for which this is not the case, can be considered. The measurement resistor is preferably a metal such as platinum. However, ceramic measurement resistors, such as sintered metal oxides or semiconductors, can also be used. In this way, greater sensitivities can be achieved, but to some extent at the expense of accuracy. Both thermocouples and resistance thermometers can be produced cost-effectively using modern printing methods.

Measurement sensors which capture the conductance of the filled products provide an indication of the concentration and type of the dissolved ions. This is significant, because the conductance of foodstuffs differs according to whether or not they are in a state suitable for consumption. The measurement sensor can have two electrodes arranged parallel or coaxially to each other, for instance in stainless steel, graphite, platinum or titanium, having a defined surface area and a defined spacing. Conductive measurement methods are considered here, which capture the ohmic resistance, or also inductive methods, which can work potential-free. Simple electrode structures for conductance measurement can be produced cost-effectively using printing methods.

Measurement sensors, which capture the oxygen content, in particular provide indications of the quality of foodstuffs, since oxygen impairs the shelf life of foodstuffs. In addition, the pH value often changes if a foodstuff deteriorates, meaning that measurement sensors that capture the pH value can be preferred. The pH value can, by way of example, be captured via a potentiometric measuring chain (potentiometry), wherein the potential difference compared to a standard electrode, also known as a reference electrode, is captured. The standard or reference method can then provide a constant potential. For pH value measurement, by way of example ion-sensitive field-effect transistors (ISFET) or EIS (Electrolyte Insulator Semiconductor) sensors can be used. An ISFET is a special kind of field-effect transistor, in which the gate contact is replaced by an ion- or pH-sensitive material (e.g. SiO₂, Al₂O₃ or Ta₂O₅). In principle an EIS sensor is the same as a metal-insulator-semiconductor structure, wherein the metal contact is replaced by the measurement electrolyte and the reference electrode and the insulator by an ion-sensitive layer (e.g. SiO₂, Al₂O₃ or Ta₂O₅). An advantage of this embodiment is, inter alia, the possibility of miniaturisation.

The transponder unit can comprise, on the on hand, at least one antenna unit and, on the other, at least one chip unit and/or at least one sensor unit. For the sake of simplicity, the transponder unit preferably is what is known as an RFID transponder or what is known as an NFC tag, which are adequately understood as such. However, other transponders for storing and non-contact transfer of information are likewise conceivable.

To extend the shelf life of the product contained in the packaging, it is appropriate if between the carrier layer and a cover layer at least one barrier layer is provided which acts as a barrier to light and gases. Therefore, the barrier layer can also be described as a gas barrier, preferably an oxygen barrier. Oxygen is of particular significance, since oxygen ingress into the packaging can significantly reduce the shelf life of foodstuffs. However, a barrier layer does not necessarily equate to impermeability. A diffusion of gases through the barrier layer cannot really be totally prevented because due to costs the barrier layer will be very thin. A barrier layer can in particular be considered as one that in relation to the other layers substantially determines the permeability. The other layers make only an insignificant contribution to the impermeability. Alternatively, or additionally, a barrier layer can have an oxygen permeability of less than 10 cm³/m² d bar and/or a water vapour permeability of less than 10 g/m² d bar, wherein d stands for the time unit day.

In the case of a barrier layer, it is preferable if at least one functional element is provided between the barrier layer and the carrier layer and/or at least one functional element between the barrier layer and the cover layer arranged on the same side of the carrier layer. The arrangement between the barrier layer and the carrier layer is in particular appropriate for the chip unit and/or the antenna unit, since here reading out of the stored information is not prevented by the barrier layer. The barrier layer is preferably provided on the inner side of the packaging in relation to the carrier layer. The arrangement between the barrier layer and the cover layer arranged on the same side of the carrier layer is in particular appropriate for the sensor unit, since here the barrier layer does not prevent interaction with the measured variable to be captured. In particular in the case of a sensor unit, it can also be preferable if at least one functional element is provided in the cover layer arranged on the same side of the carrier layer. Thus, in a simple manner the functional element can be ready prefabricated in the cover layer. In addition, the functional element can thus be brought close to or even in direct contact with the product of the packaging to allow reading out information of the state of the product. Thus, the product state can bring about reliable status changes of the at least one functional element. Alternatively, or additionally, the functional element, for instance in the form of a sensor unit, can be arranged very close to the product contained in the packaging.

Furthermore, individual functional elements can also be provided on different sides of the barrier layer. For instance, the sensor unit can be provided on the side of the adjacent cover layer in relation to the barrier layer, to allow easy capture of the measured value. The chip unit can be provided on the same side of the barrier layer, in order to allow simple and reliable storage of the measured value. However, the chip unit can be provided on the other side of the barrier layer, in order to allow simple and reliable readout of the desired information. The antenna unit is then preferably arranged on the other side of the barrier layer than the sensor unit, in order to allow simple and reliable readout of the desired information.

As the carrier layer any suitable material known to the person skilled in the art for this purpose can be used, having sufficient strength and rigidity, in particular flexural rigidity, to provide the container with sufficient stability that in the filled state the container substantially retains its form. On cost grounds, weight grounds and flexural rigidity grounds, the carrier layer is formed of a cellulose-containing fibrous material, preferably made from paper or cardboard. The grammage of the carrier layer is preferably in a range from 120 to 450 g/m², particularly preferably in a range from 130 to 400 g/m² and most preferably in a range from 150 to 380 g/m². A preferred cardboard generally has a single- or multi-layer structure and can be laminated on one or both sides with one or more cover layers. A preferred cardboard also has a residual moisture content of less than 20 wt.-%, preferably between 2 and 15 wt.-% and particularly preferably between 4 and 10 wt.-%, in relation to the total weight of the cardboard. A particularly preferred cardboard has a multi-layer structure. More preferably, the cardboard has on the surface facing the environment at least one layer, but particularly preferably two layers, of a cover layer, known to the person skilled in the art as a “coating”. In paper production liquid phases containing inorganic solid particles, preferably chalk-, gypsum- or clay-containing solutions are usually termed as a “coating” which are applied to the surface of the cardboard. A preferred cardboard also has a Scott Bond value in the region of 100 to 360 J/m², preferably of 120 to 350 J/m² and particularly preferably 135 to 310 J/m². The abovementioned ranges allow a composite to be provided from which a highly impermeable container can be folded easily and within narrow tolerances.

On the other hand, for reasons of sealability, the cover layers are formed from a thermoplastic, wherein for reasons of cost and processability a polyolefin, in particular a polyethylene, is ideally suited.

On diffusion tightness grounds, the barrier layer can be formed from metal and/or a metal oxide, wherein for reasons of weight and processability, aluminium, iron or copper, are ideally suited. Alternatively, or additionally, mineral barrier layers can also be considered as barrier layers, in particular in the form of an oxide such as for example at least one silica or titanium oxide. However, alternatively, or additionally, barrier layers made of at least one plastic can be considered. Depending on the particular requirement, this can, by way of example, be polyamide (PA), polyamide 6 (PA 6), polyacrylonitrile (PAN), polyethylene naphthalate (PEN), ethylene vinyl alcohol copolymer (EVOH/EVAL), polyvinylidene chloride (PVDC) and/or liquid crystal polymer (LCP). In the case of a metal layer a thickness in a range of 3 to 20 μm, preferably in a range of 3.5 to 12 μm and particularly preferably in a range of 4 to 10 μm, is expedient. The purity of the aluminium is preferably 97.5% or more, preferably 98.5% or more, in each case in relation to the total aluminium layer. In a particular configuration, the metal layer consists of an aluminium film. Suitable aluminium films have an elasticity of more than 1%, preferably of more than 1.3% and particularly preferably of more than 1.5%, and a tensile strength of more than 30 N/mm², preferably more than 40 N/mm² and particularly preferably more than 50 N/mm². In the pipette test, suitable aluminium films exhibit a drop size of more than 3 mm, preferably of more than 4 mm and particularly preferably of more than 5 mm. Suitable alloys for creating aluminium layers or films are obtainable under the designations EN AW 1200, EN AW 8079 or EN AW 8111.

Where a metal film is used as a barrier layer, one and/or both sides of the metal film can be provided with a layer of bonding agent between the metal film and the nearest polymer layer. However, according to a particular configuration of the container according to the invention, on neither side of the metal film, between the metal film and the nearest polymer layer, is a layer of bonding agent provided.

More preferably the barrier layer can be a metal oxide layer. For metal oxide layers, all metal oxide layers can be considered that are familiar to the person skilled in the art and appear suitable to achieve a barrier effect against light, vapour and/or gas. Particularly preferred are metal oxide layers based on the abovementioned metals of aluminium, iron or copper, and those metal oxide layers based on a titanium oxide compounds or silica compounds. A metal oxide layer is, by way of example, generated by vapour deposition of a plastic coating, by way of example an oriented polypropylene film with metal oxide. A preferred method for this is the physical vapour deposition process.

For the bonding agent in the binding agent layer all plastic materials can be considered which through functionalisation by means of suitable functional groups, by means of the formation of ion bonds or covalent bonds, are suitable for creating a solid bond with the surface of the respective other layer. Preferably functionalised polyolefins are involved which have been obtained through co-polymerisation of ethylene with acrylic acids such as acrylic acid, methacrylic acid, crotonic acid, acrylates, acrylate derivates or double-bond carrying carboxylic acid anhydrides, by way of example maleic anhydride, or at least two of these. Of these polyethylene maleic anhydride graft polymers (EMAH), ethylene acrylic acid copolymers (EAA) or ethylene methacrylic acid copolymers (EMAA) are preferred which, by way of example, are marketed under the trade names Bynel® and Nucrel® by DuPont or Escor® by ExxonMobil Chemicals.

A preferred polyolefin for at least one of the plastic layers is a polyethylene or a polypropylene or both. A preferred polyethylene is one selected from the group consisting of an LDPE, an LLDPE, and an HDPE, or a combination of at least two of these. A further preferred polyolefin is an m-polyolefin.

The at least one functional element can be accommodated in at least one plastic layer of the packaging laminate, wherein for production engineering reasons it may be particularly appropriate if the functional element is welded into the at least one plastic layer, preferably between two plastic layers. Optionally, the functional element can be inserted only upon formation of the packaging laminate, and thus at least substantially inline, in the at least one plastic layer, which is also preferably provided anyway and not simply for the purpose of accommodating the functional element. Thus, an additional layer can be saved. However, to simplify production and improve prefabrication, the at least one functional element can be already inserted or welded into at least one plastic layer in advance. The welding is particularly simple and fast if the functional element is welded between two plastic layers. The at least one plastic layer can then if necessary be employed as a strip material for producing the packaging laminate and provided between other layers of the packaging laminate. Then, additionally, preferably functional elements are provided at regular intervals, in order to be able to produce identical packaging later from the packaging laminate. However, the at least one plastic layer does not have to be incorporated in the packaging laminate as a strip material. However, it is also conceivable that to begin with individual sections of the at least one plastic layer are cut which are then provided at specified points in the packaging laminate, for instance to save material. The plastic layer then does not extend continuously along the entire packaging laminate, but is provided only in sections.

This basically means that at least one functional element can be accommodated in a separate shell, preferably made out of plastic, provided merely zonally between the adjacent layers of the packaging laminate. This simplifies the precise positioning of the functional element and increases the flexibility during production of the packaging laminate. In order to simply and durably secure the at least one functional element, for instance in its separate shell, the functional element or the shell surrounding this, can be welded into the packaging laminate. Alternatively, or additionally, the at least one functional element, which can be accommodated in or welded into a separate shell provided only zonally, can be glued to the carrier layer. This protects the functional element and makes processing easier. The gluing itself can be simplified if an adhesive is used for this purpose. As has already been pointed out above, it is furthermore particularly expedient if the separate shell provided as necessary is formed from plastic. Particular cost savings can be achieved if the at least one functional element is printed on at least one layer of the packaging laminate. The printed elements then preferably comprise conducting particles.

To avoid delamination along the carrier layer, it can be expedient to glue the barrier layer with at least one adjacent layer by means of a layer of adhesive. Since metal barrier layers in particular generally do not bond satisfactorily with the carrier layers, it is often particularly appropriate to glue the carrier layer to the barrier layer by means of a layer of adhesive. The layer of adhesive can then be used in a preferred manner to accommodate the at least one functional element in the layer of adhesive. Thus, the functional element is at least partially securely and durably integrated into the laminate. Furthermore, the adhesive allows the thickness of the laminate to be evened out in the region of the functional element, for which reason the adhesive layer may be preferred even if it is unnecessary for bonding the adjacent layers. At the site of the functional element if necessary less adhesive may be provided than in adjacent regions in order to provide an even layer thickness of the adhesive layer integrating the functional element.

To reduce stress peaks at edges, which may contribute to a delamination of the packaging laminate, the blanks of the shells could also be further rounded or also stamped ready-rounded from the strip material. Here a peripheral rounding along an edge of the cut shells and/or a rounding of the edges of the cut shells in a direction perpendicular to the blank can be considered. This can also be referred to as a two-dimensional or three-dimensional rounding, depending on the plane in which the roundings are arranged. The more pronounced the at least one rounding is, the lower the stress peaks and the tendency to delaminate are.

In order that the packaging laminate does not have an uneven thickness and if necessary so as to better protect the at least one functional element, the at least one functional element can at least partially be accommodated in a zonally provided pocket in the carrier layer. Hence, to begin with a pocket is provided, in which the at least one functional element can be easily introduced at least partially. Here it is essentially of less significance if the functional elements are applied individually and separately or as part of a strip material in the packaging laminate. In order to be able to rapidly and reliably provide a sufficient pocket in the carrier layer, the carrier layer can by way of example be compressed in the longitudinal direction of the packaging laminate or at regular intervals. This compression is achieved simply and reliably by pressing the carrier layer with suitable pressing tools. To this end, the fibrous carrier layer is compressible and provided so that once the compression has taken place the carrier layer is retained compressed for a sufficiently long time to be able to apply the at least one functional element. However, instead of or in addition to a corresponding compression, removal of material from the carrier layer may also be considered. Where the material is removed from the carrier layer, the at least one functional element can then be provided without any problem. A rather more extensive removal of material can be provided easily and quickly if necessary by punching out a section of the carrier layer.

To be able to expediently provide packaging with at least one functional element and at the same time produce the packaging simply, it is appropriate to produce a packaging blank according to any one of claims 1 to 8.

For the same reasons, it can also be appropriate to produce a packaging sleeve from a packaging laminate according to any one of claims 1 to 8 and/or from a packaging blank according to claim 8, wherein the packaging blank is bonded, preferably welded or glued, on opposing edges, and in particular forms the packaging sleeve.

Accordingly, a preferred packaging from the functional and production engineering point of view is obtained if the packaging is produced from a packaging laminate according to any one of claims 1 to 8, preferably from a packaging sleeve according to claim 10. Here, for ease of handling, the packaging also has a packaging top, a packaging base and a sleeve section, wherein the packaging top, packaging base and sleeve section are closed so that they are fluid-tight, in particular sealed.

In a first, particularly preferred configuration of the method, functional elements in the form of chip units, antenna units, sensor units and/or transponder units are used, as already adequately described above in connection with the packaging laminate.

Between the carrier layer and a cover layer, at least one barrier layer configured as a gas barrier, preferably an oxygen barrier, can be provided, to provide a barrier against light or particular gases, which is or are not intended to reach the inside of the packaging and thus the product contained in the packaging, or only to a very limited extent. To this end, the barrier layer can be introduced as a strip material and provided in the packaging laminate. Thus, a prefabrication and simplification of the production process can be achieved. But the barrier layer can also if necessary be created during production of the packaging laminate. Depending on the material used to this end extrusion, vapour deposition and/or sputtering can be considered.

Where a barrier layer is provided, it can be particularly functional if at least one functional element is arranged, preferably at regular intervals, between the barrier layer and the carrier layer. Thus, the desired information can be reliably read out, in particular if the at least one functional element is an antenna unit and/or a chip unit. Thus, by way of example, disruption of the readout by the barrier layer is avoided. Alternatively, or additionally, the at least one functional element can be provided, preferably at regular intervals, between the barrier layer and the cover layer arranged on the same side of the carrier layer. This is particularly the case for the sensor unit and/or the chip unit, if it is intended to read out information on the state of the product contained in the packaging. Thus, these can be placed close enough to the product that a change of state of the product can indicate a change of state of the sensor unit and/or chip unit. The latter notably applies if at least one functional element is provided, preferably at regular intervals, in the cover layer arranged on the same side of the carrier layer. The functional element can thus be brought close to or even in direct contact with the product of the packaging.

Also according to the method, the at least one carrier layer, the at least one cover layer, and the at least one barrier layer, can be formed from the materials already described in connection with the packaging laminate, wherein according to the method a simplification is achieved if the carrier layer is fed as a strip material and integrated into the packaging laminate. The cover layers and the barrier layers, to the extent that these are formed from at least one thermoplastic, can also initially be produced in line with the packaging laminate production, for instance during the extrusion. With metal barrier layers, in particular barrier layers made of aluminium, on cost grounds and to save on material it can be appropriate to apply the barrier layer to a substrate layer of the packaging laminate by vapour deposition or sputtering. Otherwise, an aluminium or metal film can be used as the barrier layer if necessary.

For ease of application and to protect the at least one functional element, this can be accommodated in or welded into at least one plastic layer, wherein welding-in in particular between two plastic layers is appropriate in order to simplify the production process. In addition, the functional element introduced into the at least one plastic layer can be bonded with at least one further layer of the packaging laminate in order to secure the functional element in the packaging laminate. Here, the at least one plastic layer can be fed as a strip material and integrated as a continuous layer in the packaging laminate. This simplifies and evens out the structure of the packaging laminate. But to save material, the strip material can also be used simply as material strips provided zonally, in particular lengthways, in the packaging laminate. In both cases, the intervals of the functional elements in the at least one plastic layer can be prefabricated in such a way that the intervals of the functional elements in the subsequent packaging laminate through the introduction of the plastic layer are provided lengthways such that the packaging laminate allows the simple production of a whole series of uniform packaging. Otherwise, the plastic layer can be prefabricated with a series of functional elements as a strip material, from which the functional elements can be cut in order and, accommodated in the respective plastic shell, bonded with at least one layer of the packaging laminate. The application of the functional elements then preferably takes place at regular intervals which allows a whole series of uniform packaging to be simply produced from the packaging laminate.

Essentially, the functional elements can also be accommodated in a shell made from a material other than plastic although this will probably be preferred for particular applications only. Irrespective of the configuration of the shell, this can be glued to at least one other layer of the packaging laminate, with or without the use of an adhesive. Basically, however, a plastic layer can also be laminated over the at least one functional element or the corresponding shell enclosing the functional element. This can result in an additional material requirement, if the plastic layer serves only for mounting the functional element. However, this can take place rapidly, reliably and simply, contributing to lower packaging laminate production costs.

Under certain conditions it may be preferred to bond the functional elements at regular intervals, if necessary in a shell of the type already described, with a cover layer or another layer such as, in particular, the carrier layer. The former allows a simple bonding, if necessary without the addition of an adhesive. The latter protects and supports the functional element, even if as necessary the addition of an adhesive is required for the bonding. Here, irrespective of the layer of the packaging laminate, with which the functional element is bonded, for the sake of simplicity gluing is selected as the joining method.

To lower the costs of the production of the functional elements, even if this slows down production of the packaging laminates and makes it more difficult, it is appropriate that at least one functional element is printed on at least one layer of the packaging laminate. Since the carrier layer provides a high degree of flexural rigidity, which can have an advantageous effect on the durability of the printed functional element in the subsequent handling of the carrier layer or the packaging laminate, it is expedient to print the functional element on the carrier layer. However, depending on the carrier layer its material may make printing harder. On the other hand, the printing can take place simply and reliably on a flat surface, for which reason it can be particularly expedient to print the functional elements on a plastic layer, that is applied or has been applied to the carrier layer. The functional element is preferably printed on the carrier layer or a plastic layer of the packaging laminate. For this common printing methods such as the flexo, screen, gravure or digital printing processes can be considered. The printing inks should also contain conductive, in particular metallic, particles to be able to provide the functional elements, in particular integrated circuits. The printing of the functional elements can take place during prefabrication or inline during production of the packaging laminate on one of the layers of the packaging laminate.

The functional elements can be protected from external disturbance or the packaging laminate can be configured to be thinner and protect the material more, if the carrier layer is provided zonally with at least one pocket, preferably at regular intervals. Then, the at least one functional element can be provided at least partially in the at least one pocket. For its part, the pocket can be formed by pressing and compressing the carrier layer, by removal of material from the carrier layer, by punching out at least a part of the carrier layer, or in another manner. The at least one functional element can be easily and cost-effectively at least partially accommodated in the at least one pocket in the carrier layer, in that the functional element is glued to the carrier layer or in that on the carrier layer a further layer covering the pocket is provided. If the carrier is entirely removed locally, the functional element can be bonded with the adjacent material layer of the packaging laminate, in particular glued.

In order to produce packaging blanks according to the method of the type already described by employing the advantages already discussed in connection with the packaging laminate, it is appropriate to produce a packaging laminate according to any one of claims 11 to 16 and then to separate a part of the packaging laminate. Here it is appropriate, for the sake of simplicity if from the initially produced packaging laminate longitudinally a whole series of, in particular uniform, packaging blanks is cut out.

The advantages already discussed for the packaging laminate can, according to the method, also be employed for the production of a packaging sleeve, if initially a packaging laminate according to any one of claims 11 to 16 or a packaging blank according to claim 18 is produced and opposing edges of the packaging laminate or the packaging blank are bonded together, preferably welded or glued together. Preferably, in this way a longitudinal seam of a packaging sleeve is formed the longitudinal side of which is then still open. The longitudinal seam or the corresponding bonding of the opposing edges of the packaging laminate and/or the blank can, if necessary, also be achieved using an adhesive tape. Here the adhesive tape can be simply wrapped between the overlapping edges and/or around at least one edge.

However, alternatively or additionally, the advantages according to the method of the packaging laminate production, can also be employed for the production of a packaging sleeve, if initially a packaging laminate according to any one of claims 11 to 16 or a packaging blank according to claim 18 and then a packaging top, a packaging base and a sleeve section are produced. So that no product to be filled can inadvertently leak from the packaging, it is also appropriate to close, in particular to seal, the packaging top, the packaging base and the sleeve section so that they are fluid-tight.

Regarding the structure of the packaging laminate, it can basically be established that the said layers can basically be directly or indirectly bonded to one another unless otherwise indicated. In addition, with a direct bonding also, a bonding agent or an adhesive can be used between the layers directly bonded together. Furthermore, the layers can completely consist of the materials indicated or comprise supplementary materials such as fillers or additives. By way of example, organic or inorganic substances, dyes, carbon black and metal oxides can be considered.

In the following, the invention is described in more detail based on a drawing representing merely exemplary embodiments. In the drawings:

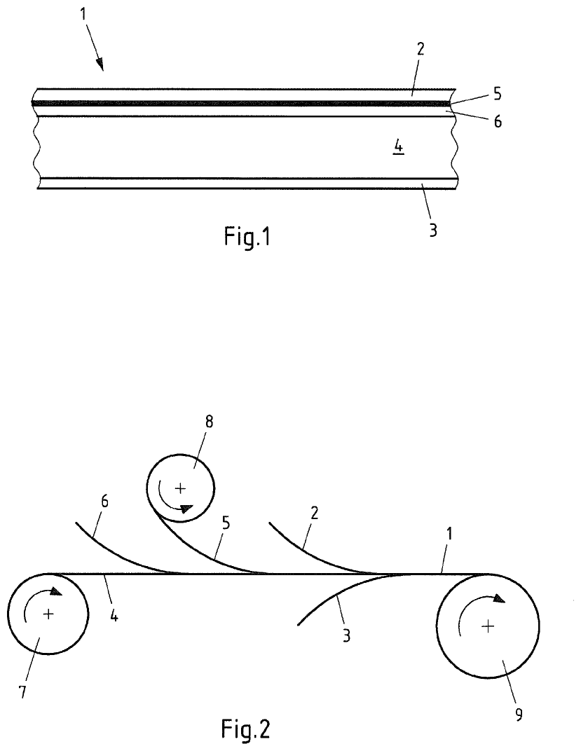

FIG. 1 shows a basic structure of a packaging laminate in a schematic side view;

FIG. 2 shows a basic production of the packaging laminate in a schematic side view;

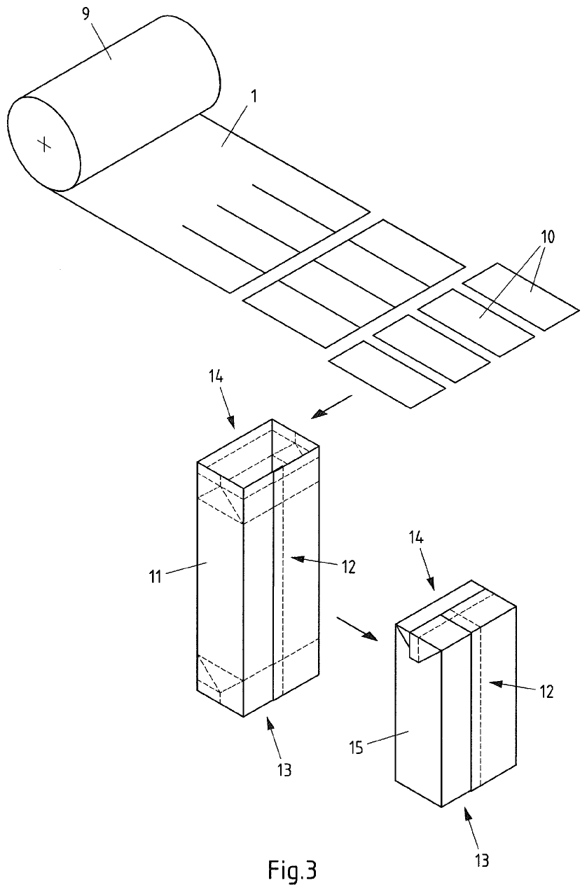

FIG. 3 shows a basic production of packaging blanks, packaging preforms or packaging made from a packaging laminate;

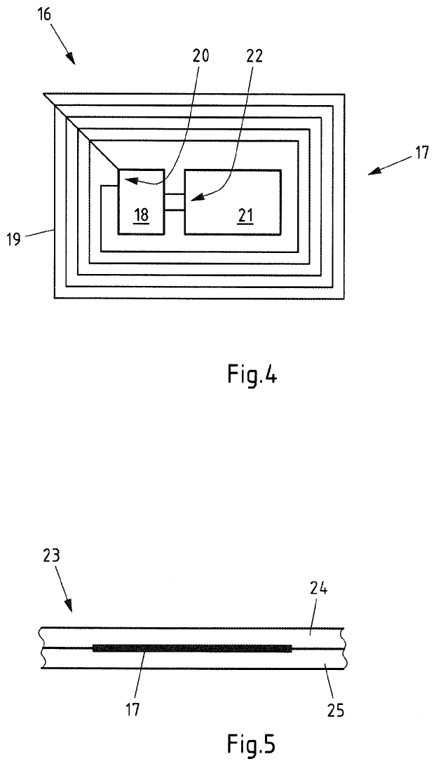

FIG. 4 shows a basic configuration of the transponder unit in a schematic top view;

FIG. 5 shows a transponder unit accommodated in a shell in a schematic side view;

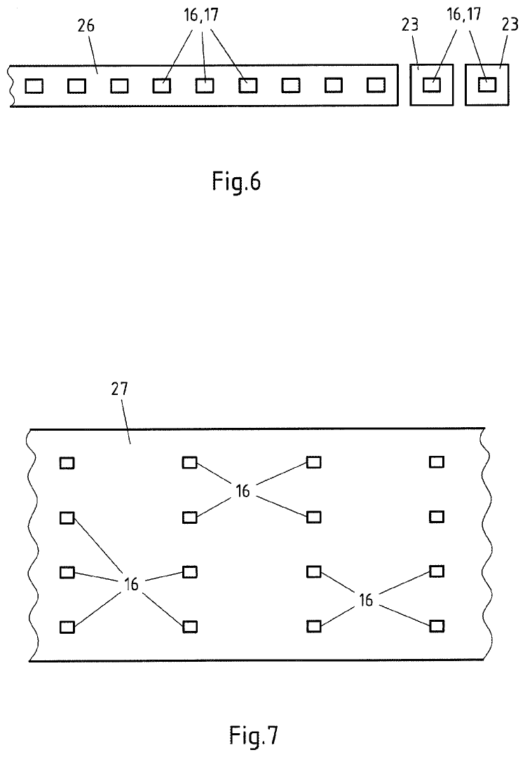

FIG. 6 shows a series of transponder units prefabricated in a strip material in a schematic top view;

FIG. 7 shows a series of transponder units prefabricated in an alternative strip material in a schematic top view;

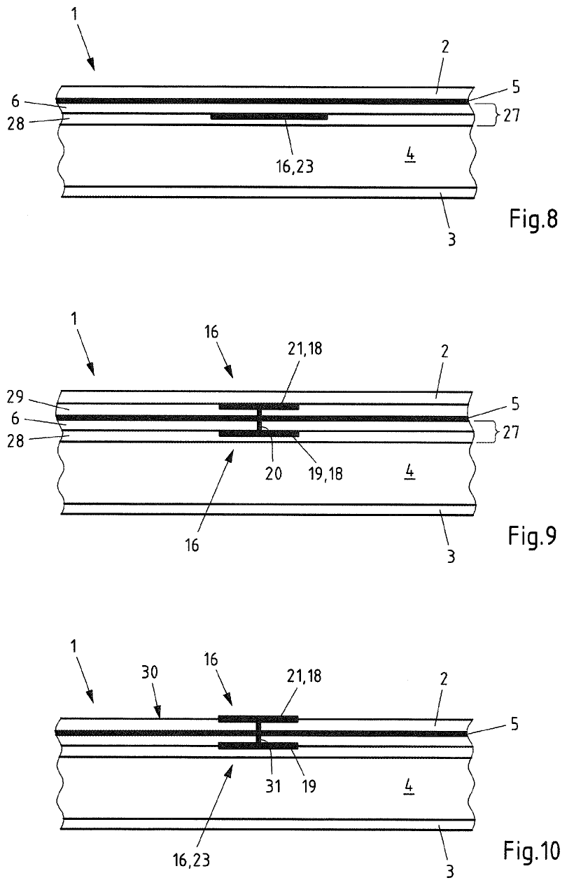

FIG. 8 shows a first packaging laminate according to the invention in a schematic side view;

FIG. 9 shows a second packaging laminate according to the invention in a schematic side view;

FIG. 10 shows a third packaging laminate according to the invention in a schematic side view;

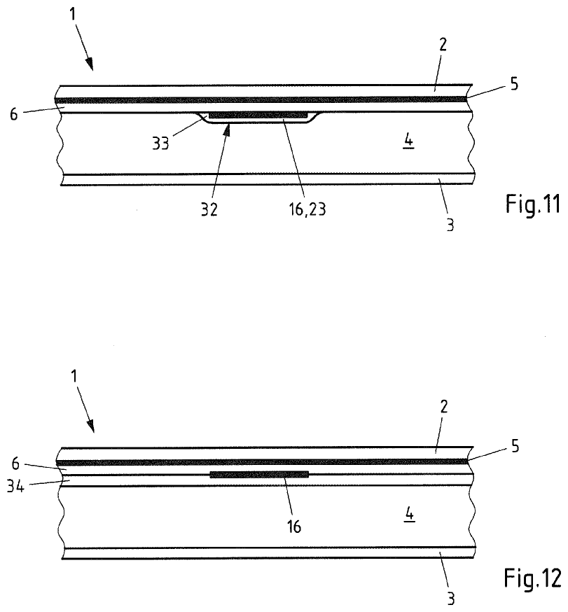

FIG. 11 shows a fourth packaging laminate according to the invention in a schematic side view; and

FIG. 12 shows a fifth packaging laminate according to the invention in a schematic side view.

FIG. 1 represents an exemplary basic structure of a packaging laminate 1 in a schematic side view. Essentially, other structures of packaging laminates 1 can also be considered, but the structure represented is widely used in practice. In the exemplary embodiment represented and in this respect preferred, the packaging laminate 1 comprises two outer cover layers 2, 3, a carrier layer 4 provided between them and a barrier layer 5. The carrier layer 4 is a fibrous layer in cardboard, while the barrier layer 5 is an aluminium layer, which can usually be bonded with the carrier layer 4 only indirectly, to avoid undesired delamination. Therefore, between the carrier layer 4 and the barrier layer 5 a further plastic layer in the form of a bonding layer 6 is provided, which bonds the carrier layer 4 with the barrier layer 5. In the packaging laminate 1 represented and in this respect preferred, the cover layers 2, 3 and the bonding layer 6 provided between the carrier layer 4 and the barrier layer 5 are made of polyethylene (PE). The cover layer 2 adjacent to the barrier layer 5 forms in the packaging the inner layer associated with the filled product, while the cover layer 3 facing away from the barrier layer 5 forms the outer layer of the packaging facing away from the filled product, which is usually printed with a design and/or product information. In this case, for simplicity, the corresponding print is not considered to be a further layer of the packaging laminate 1, but a part of the cover layer 3.

The production of the packaging laminate 1 from FIG. 1 is represented schematically in FIG. 2. The carrier layer 4 is transported wound as a strip material on a roll 7 and then unwound. On both sides of the carrier layer 4 by means of extrusion a polyethylene plastic film is created, which forms a cover layer 2 and the bonding layer 6 for bonding the carrier layer 4 and barrier layer 5. Before the plastic films are cooled, they are bonded with opposing sides of the carrier layer 4. In parallel, the barrier layer 5 in the form of an aluminium film is unwound from a roll 8 and bonded with the bonding layer 6 for bonding carrier layer 4 and barrier layer 5. On the outer side of the barrier layer 5 the cover layer 3 is applied in the form of a further plastic film, which is similarly generated inline by means of extrusion. The barrier layer 5 can if necessary also be vapour deposited on the bonding between carrier layer 4 and barrier layer 5, where the barrier layer 5 involves an aluminium. Once the individual layers of the packaging laminate 1 have been bonded with one another, the packaging laminate 1 can be wound onto a roll 9 for subsequent use.

FIG. 3 describes a possible production of packaging blanks 10, packaging sleeves 11 and packaging 12 from a packaging laminate 1. The packaging laminate 1 is provided as a strip material and unwound from a roll 9. In the example represented, the packaging material 1 is then cut initially at regular intervals longitudinally and then at regular intervals transversally, in order to obtain in this way a plurality of packaging blanks 10, from which in each case by folding, turning over and sealing the opposing edges a packaging sleeve 11 with a longitudinal seam 12 can be formed. The packaging sleeves 11 are initially open on their longitudinal sides 13, 14. Then, a longitudinal side 13 can be closed and the packaging preform thereby obtained filled with a product. Next, the other longitudinal side 14 can also be closed, so that a packing 15 is obtained comprising the pack formed from the packaging laminate 1 and the product with which it is filled.

FIG. 4 represents a functional element 16 in the form of a transponder unit 17. Here, the transponder unit 17 comprises two separate functional elements 16, namely a chip unit 18 with an integrated circuit and an antenna unit 19, which is connected via two connections 20 or contacts with the chip unit 18. In addition, a further sensor unit 21 can be provided which can then similarly be connected via two connections 22 or contacts with the chip 18 unit and/or the antenna unit 19. Here, the sensor unit 21 comprises at least one measurement sensor, which can be influenced by the state of the packaging 15 and/or the state of the product contained in the packaging 15. A signal dependent on this influencing is sent by the antenna unit 19 in order to transmit information on the state of the packaging 15 and/or the state of the product contained therein. Measurement sensors considered are those for capturing the temperature of a substance, the concentration of a substance, the pH value, the conductance and similar.

FIG. 5 represents a functional element 16 in the form of a transponder unit 17 from FIG. 4 accommodated in a shell 23 in a schematic side view. In this case, the shell 23 consists of two plastic films 24, 25 which enclose the transponder unit 17 and which are welded together. Consequently, the functional element 16 is arranged between the two plastic films 24, 25.

FIG. 6 represents a series of functional elements 16 prefabricated in a strip material 26 in the form of transponder units 17 in top view. The strip material 26 is made from two parallel plastic films 24, 25 welded together, between which the functional elements 16 are arranged at regular intervals. At regular intervals sections are then cut from the strip material 26 in order to obtain shells 23 according to FIG. 5 with the functional elements 16 accommodated therein. The shells 23 can then be introduced at regular intervals in the packaging laminate 1 during production of the packaging laminate 1, so that uniform packagings 15 can be formed from the packaging laminate 1, which all comprise a corresponding shell 23 or a corresponding functional element 16. Here it is particularly appropriate if the shells 23 or the functional elements 16 are positioned between the carrier layer 4 and an adjacent bonding layer 6 of the barrier layer 5.

To reduce stress peaks at edges, which may contribute to a delamination of the packaging laminate, the blanks of the shells 23 could also be rounded or also stamped ready-rounded from the strip material 26, although this is not represented in detail. Here a peripheral rounding along the edge represented in FIG. 6 of the cut shells 23 and/or a rounding of the edges of the cut shells 23 in a direction perpendicular to the blank or drawing plane can be considered. This can also be referred to as a two-dimensional or three-dimensional rounding, depending on the plane in which the roundings are arranged. The more pronounced the at least one rounding is, the lower the stress peaks and the tendency to delaminate are.

In FIG. 7 a plastic strip material 27 is represented, which can be accommodated as such in particular as a bonding layer 6 between the carrier layer 4 and the barrier layer 5 or as the barrier layer 5 itself longitudinally in the packaging laminate 1. Then, by way of example, a plastic layer is not produced inline during production of the packaging laminate 1 by extrusion, but is unwound from a roll as a strip material 27. The functional elements 16 are then applied in advance at regular intervals, so that upon introduction of the corresponding strip material 27 into the packaging laminate 1 a packaging laminate 1 is obtained, from which a series of uniform packagings 15 in each case with a functional element 16 of the abovementioned type can be formed.

FIG. 8 represents a packaging laminate 1 in a schematic side view. Here, the layer structure basically corresponds to the layer structure of the packaging laminate 1 according to FIG. 1. However, in contrast the strip material 27 according to FIG. 7 is provided instead of the bonding layer 6 between the carrier layer 4 and the barrier layer 5. The packaging laminate of FIG. 8 may involve between the carrier layer 4 and the barrier layer 5, a bonding layer 6 and an adhesive layer 28, into which the functional element 16 is impressed. The adhesive layer 28 can then be glued to the bonding layer 6 or optionally also directly to the barrier layer 5. In the latter case material can be saved, although this is not represented in detail in FIG. 8. In addition, the functional element 16 can be incorporated in the packaging laminate 1 in a shell 23 that has already been described.

FIG. 9 represents an alternative packaging laminate 1 in a schematic side view. In contrast to the packaging laminate 1 from FIG. 1, here at least one functional element 16 in the form of a sensor unit 21 is provided on a plastic layer configured as a mounting layer 29, provided on the outer side of the barrier layer 5. Here it can also be an extruded plastic layer, in which a shell 23 according to FIG. 5 or 6 has been inserted, before the adjacent cover layer 2 is applied. But here also other production methods are conceivable, which lead to the same layer structure and as necessary have already been described above. Furthermore, on the opposite side of the barrier layer 5 a further functional element 16, at least in the form of an antenna unit 19, is provided, as has already been described in connection with FIG. 8. This is particularly appropriate for metal barrier layers 5 through which no radio signal can be transmitted. These two functional elements 16, which essentially can also be provided by other means on opposite sides of the barrier layer 5, are connected together across the barrier 5 by means of at least two connections 20 or contacts. The antenna unit 19 and/or the sensor unit 21 can also be associated with a chip unit 18. Through the arrangement of the functional elements 16 on both sides of the barrier layer 5, the state of the product in the packaging 2 can be satisfactorily captured and information on this read out from outside the packaging 2.

FIG. 10 represents an alternative packaging laminate 1 to the packaging laminate 1 represented in FIG. 9, in which on the side of the barrier layer 5 facing away from the carrier layer 4 just one plastic layer is provided, namely the cover layer 2. Here, the functional element 16, which can preferably be a sensor unit 21 and if necessary additionally a chip unit 18, is integrated at least partially in the cover layer 2. Here, the functional element 16, in particular the sensor unit 21, forms in sections the corresponding outer side 30 of the cover layer 2 or even protrudes partially outwards from the cover layer 2. Thus, via the measurement sensor of the sensor unit 21 possibly a measured value can be captured very quickly, accurately and reliably. However, the measurement sensor can be easily damaged in this way. The sensor unit 21 and as necessary the chip unit 18 is/are in particular in the case of a metal barrier layer 5 as in the packaging laminate 1 according to FIG. 9 connected with an antenna unit 19 on the other side of the barrier layer 5 across the barrier layer 5 by means of two connections 31. Otherwise the antenna unit 19 is unable to satisfactorily transmit signals through the barrier layer 5. Here, the antenna unit 19, with the packaging laminate 1 according to FIG. 9, is provided between the barrier layer 5 and the transport layer 4 and can be provided in an already described shell 23. Essentially, however, an application that differs from that represented in FIG. 9 would also be conceivable.

FIG. 11 represents an alternative packaging laminate 1 in a schematic side view. In contrast to the packaging laminate 1 from FIG. 1, here at least one pocket 32 is provided in the carrier layer, in which a functional element 16 is accommodated at least partially. The pocket 32 can, by way of example, be formed by pressing and local compression, through material removal or by complete or partial stamping out of material from the carrier layer 4. The functional element 16 can, by way of example, be inserted or glued in the pocket 32. It is also appropriate if the functional element 16 is accommodated in a shell 23 according to FIG. 5, in order not to damage the functional element 16 during insertion in the pocket 32. By way of example, in the pocket 32 an adhesive 33 can initially be introduced, in which the functional element 16 or the functional element 16 accommodated in a shell 23 is impressed. Via the overcoating with a plastic film, for instance the bonding layer 6, a flat packaging laminate 1 is again obtained.

FIG. 12 represents an alternative packaging laminate 1 in a schematic side view. In contrast to the packaging laminate 1 from FIG. 1, here a plastic layer in the form of a substrate layer 34 is provided between the bonding layer 6 between the carrier layer 4 and the barrier layer 5. The substrate layer 34 is applied by production engineering means first to the carrier layer 4, whereas the plastic layer can first be created, but does not have to be, inline by extrusion. Then at least one functional element 16 is printed on the substrate layer 34, preferably by gravure printing or flexo printing. The printing ink has correspondingly conductive particles, which form the functional element 16. On the at least one printed functional element 16, a further plastic layer, for instance in the form of a bonding layer 6, can then be applied in order to protect the printed functional element 16 and if necessary to bond the barrier layer 5.

It should basically be noted that individual layers described for different exemplary embodiments of a packaging laminate can also be combined in another way and if necessary with further layers or elements. It is hardly possible to represent here with reasonable effort, all layer structures or embodiments that are conceivable and suitable for particular applications.

### LIST OF REFERENCE NUMERALS

1 Packaging laminate

2, 3 Cover layer

4 Carrier layer

5 Barrier layer

6 Bonding layer

7, 8, 9 Roll

10 Packaging blank

11 Packaging sleeve

12 Longitudinal seam

13, 14 Longitudinal side

15 Packaging

16 Functional element

17 Transponder unit

18 Chip unit

19 Antenna unit

20 Connections

21 Sensor unit

22 Connections

23 Shell

24, 25 Plastic films

26, 27 Strip material

28 Adhesive layer

29 Mounting layer

30 Outer side

31 Connections

32 Pocket

33 Adhesive

34 Substrate layer

1-19. (canceled)

20. A packaging laminate for forming a packaging for flowable products, comprising a structuring carrier layer made of a fibrous material, and outer cover layers made of plastic,
characterised in that
at least one functional element designed as a chip unit and antenna unit or as a transponder unit, is provided between the carrier layer and a cover layer, preferably at regular intervals, in that the at least one cover layer is provided continuously in the region of the functional element, in that between the carrier layer and the at least one cover layer, at least one barrier layer, configured as a gas barrier, preferably an oxygen barrier, is provided and in that the at least one functional element is provided between the barrier layer, which is provided continuously in the region of the functional element, and the transport layer.

21. The packaging laminate according to claim 20,
characterised in that
the chip unit comprises at least one microchip, connections for connecting the chip unit to an antenna unit and, as necessary, a carrier element for accommodating the microchip and/or in that the antenna unit comprises at least one conductor path, preferably a conductor spiral or conductor coil, connections for connecting the antenna unit to a chip unit and, as necessary, a carrier element for accommodating the conductor path and/or in that the transponder unit comprises on the one hand at least one antenna unit and on the other at least one chip unit and/or at least one sensor unit.

22. The packaging laminate according to claim 20,
characterised in that
the carrier layer is made of a cellulose-containing fibrous material, preferably of paper or cardboard and/or in that the cover layers are made of a thermoplastic, preferably a polyolefin, in particular of polyethylene, and/or in that the barrier layer is made of metal, preferably of aluminium, of a mineral layer and/or of plastic, preferably of polyamide (PA), polyamide 6 (PA 6), polyacrylonitrile(PAN), polyethylene naphthalate (PEN), ethylene vinyl alcohol copolymer (EVOH/EVAL), polyvinylidene chloride (PVDC) and/or liquid crystal polymer (LCP).

23. The packaging laminate according to claim 20,
characterised in that
the at least one functional element is accommodated in at least one plastic layer of the packaging laminate, in particular welded, and/or in that the at least one functional element is accommodated in a separate shell, preferably made of plastic, provided only zonally between the adjacent layers of the packaging laminate, in particular welded, and/or in that at least one functional element, preferably accommodated or welded in a separate shell, in particular made of plastic, provided only zonally, preferably using an adhesive, is glued to the carrier layer, and/or in that the at least one functional element is printed on at least one layer, in particular in the form of a substrate layer of the packaging laminate.

24. The packaging laminate according to claim 21,
characterised in that
the carrier layer is glued to the barrier layer via an adhesive layer and in that, preferably, the at least one functional element is accommodated at least partially in the adhesive layer.

25. The packaging laminate according to claim 20,
characterised in that
the at least one functional element is accommodated at least partially in a pocket of the carrier layer provided zonally and in that, preferably, the pocket is provided by compression of the carrier layer, by material removal from the carrier layer and/or by punching out a section of the carrier layer.

26. A packaging blank produced from a packaging laminate according to claim 20.

27. A packaging sleeve produced from a packaging laminate according to claim 26, wherein opposing edges of the packaging blank are bonded, preferably welded or glued together.

28. A packaging produced from a packaging laminate according to claim 20, having a packaging top, a packaging base and a sleeve section, wherein the packaging top, the packaging base and the sleeve section are closed so that they are fluid-tight, in particular sealed.

29. A method for producing a packaging laminate for forming a packaging for flowable products,
in which a structuring carrier layer made of a fibrous material is bonded with outer cover layers made of plastic, in particular laminated, and
in which at least one functional element designed as a chip unit and antenna unit or as a transponder unit, is provided between the carrier layer and the cover layer, preferably at regular intervals,
in which between the carrier layer and the cover layer, which is provided continuously in the region of the functional element, at least one barrier layer configured as a gas barrier, preferably as an oxygen barrier, is provided and
in which at least one functional element, is provided, preferably at regular intervals, between the barrier layer, which is provided continuously in the region of the functional element, and the carrier layer.

30. The method according to claim 29,
in which at least one microchip, connections for connecting the chip unit to an antenna unit and, as necessary, a carrier element for accommodating the chip unit comprising the microchip is used and/or
in which at least one conductor path, preferably conductor coil, connections for connecting the antenna unit to a chip unit and, as necessary, a carrier element for accommodating the antenna unit comprising the conductor path is used and/or
in which at least one sensor unit having a measuring sensor and/or measuring transducer that can be influenced by a measured variable is used and/or
in which on the one hand, at least one antenna unit and, on the other, at least one transponder unit having a chip unit and/or at least one sensor unit is used.

31. The method according to claim 29,
in which the carrier layer is made of a cellulose-containing fibrous material, preferably of paper or cardboard and/or in that the cover layers are made of a thermoplastic, preferably a polyolefin, in particular of polyethylene, and/or in that the barrier layer is made of metal, preferably of aluminium, of a mineral layer and/or of plastic, preferably of polyamide (PA), polyamide 6 (PA 6), polyacrylonitrile(PAN), polyethylene naphthalate (PEN), ethylene vinyl alcohol copolymer (EVOH/EVAL), polyvinylidene chloride (PVDC) and/or liquid crystal polymer (LCP).

32. The method according to claim 29,
in which the at least one plastic layer, in which at least one functional element is accommodated or welded in a plastic layer, is bonded with at least one further layer of the packaging laminate and/or
in which the at least one functional element, preferably accommodated in a shell, in particular made of plastic, is bonded with a layer of the packaging laminate, preferably glued and over the at least one functional element a plastic layer is laminated and/or
in which a functional element, preferably accommodated in a shell, in particular made of plastic, is at least partially introduced into a plastic layer or an adhesive layer of the packaging laminate, preferably impressed and/or
in which at least one functional element, in particular at regular intervals, at least accommodated in a shell, in particular made of plastic, is bonded with a layer other than the cover layer, preferably the carrier layer, in particular glued and/or
in which at least one functional element is printed on a layer, preferably the carrier layer or a plastic layer, for instance as a substrate layer, of the packaging laminate.

33. The method according to claim 29,
in which in the carrier layer zonally, preferably at regular intervals, at least one pocket is provided, preferably impressed, inserted by material removal and/or stamped in, and
in which at least one functional element is at least partially introduced into the at least one pocket and
in which, preferably the at least one functional element is secured in the pocket of the carrier layer, preferably by gluing to the carrier layer or applying a further layer of packaging laminate to the carrier layer.

34. A method for producing a packaging blank,
in which a packaging laminate is produced according to claim 29 and part of the packaging laminate is separated.

35. A method for producing a packaging sleeve,
in which a packaging laminate according to claim 29 is produced and
in which opposing edges of the packaging laminate are bonded together, preferably welded together.

36. A method for producing a packaging,
in which a packaging laminate according to claim 29 is produced and
in which a packaging top, a packaging base and a sleeve section are produced and closed off so that they are fluid-tight, in particular sealed.
